(19) United States
(12) Patent Application Publication
(10) Pub. No.: US 2007/0083428 A1
(43) Pub. Date: Apr. 12, 2007

(54) System and method for navigation by advertising landmark

(76) Inventor: Susanne Goldstein, Boston, MA (US)

Correspondence Address: L.A. Husick, 201 N. Jackson St., Media, PA, 19063, US

(21) Appl. No.: 11/248,597

(22) Filed: Oct. 12, 2005

(51) Int. Cl. G07G 1/14; G06Q 30/00

(52) U.S. Cl. 705/14

(57) ABSTRACT

The invention comprises a system and method for advertising by the display of routes of travel in which advertisements are employed as sensory landmarks positioned on or near the route of travel. Selection of the particular landmark advertisement to be displayed may be according to a variety of methods such as direction of approach, proximity to direction of travel, personal user profile or preferences, Internet “cookies,” referring site information, or other methods.

### BACKGROUND OF THE INVENTION

Every day, millions of users employ Internet-based mapping systems, as well as portable and in-vehicle navigation systems to plot routes of travel from a departure point to a destination point, often via specified intermediate points. Systems for generating such routes of travel typically produce maps showing the route, turn-by-turn textual directions for the route, or a combination of both. Often, the systems are also able to indicate the locations of “points of interest” on or near the route of travel, or simply within the area of the displayed map containing the route of travel.

Typically, such systems produce directions that are confusing to users who are more oriented to a spatial model based on landmarks because they lack a consistent presentation of such landmarks on either the map, the textual directions, or both. Green (In-Vehicle Information: Design of Driver Interfaces for Route Guidance, paper presented at the Transportation Research Board Meeting, January, 1996, Washington, D.C. session 258B, Hot Topics in Freeway Operations: Compatibility of Information to Motorists.) determined that in Japan, directions are most commonly given with graphic maps, with major buildings serving as landmarks, while in the United States, directions are most often textual, with traffic controls (lights, stop signs, and the like) serving as landmarks, e.g., “go to the second traffic light and turn left.”

Even the use of traffic controls, however, is not preferred by users with a landmark orientation and preference. Smelser, et al. (International Encyclopedia of the Social and Behavioral Sciences, p. 14772, Oxford, Pergamon Press, 2001.) point out that, “[A] landmark aids orientation by serving as a key to knowledge of spatial relations stored in an internal cognitive or external cartographic map.”

Further, even where directions contain landmarks along the route of travel, they are often points of interest that fail to function as visual indicators that a driver is meant to take note of. This is due to the fact that the compilation of points of interest has not heretofore been done with particular attention to their sensory and cognitive value as navigational markers on a particular route of travel.

Typical of the prior art is U.S. Pat. No. 6,498,982 to Bellesfield, et al. which discloses an automated travel planning apparatus that includes three separate databases: a map database, a routing database, and a places of interest database. In response to user input a bit-mapped image from the map database is displayed, a departure point and a destination point are indicated, and a route between them is computed and displayed. Only if the user requests a list of places near the displayed route, is the places of interest database used to generate and display a list of places of interest which are within a predetermined distance of the generated route.

### SUMMARY OF THE INVENTION

Because it is known that many people prefer, and are better able to navigate a set of travel directions by the use of landmarks (sensory cues at particular geographic locations proximate to the route of travel,) the present invention provides for the incorporation of both textual and graphic landmarks within textual and graphic directions for routes of travel. In so doing, the present invention comprises a system and method for advertising and sponsorship that utilizes paid-for landmark “advertisements” (be they on a commercial or public building, a billboard, a sign or other type visual indicator) along a requested route of travel that are employed as sensory landmarks embedded within graphic or textual instructions that aid drivers in traveling along a requested route. Selection of the particular landmark advertisement to be displayed may be according to a variety of methods such as direction of approach, proximity to direction of travel, personal user profile or preferences, Internet “cookies,” referring site information, or other methods.

By using advertisements, the present invention creates a new form of advertising space or “inventory”—specifically, geographic locations, visible from requested travel routes, having recognizable features that may be represented within travel directions. Such “inventory” may be created by processing databases of geographic nodes (comprising roads, intersections, and other geographic features) to create a list of available locations, and then, for example, using geolocation information to cross-tabulate the available locations to a list of commercial establishments such as a yellow pages, or similar lists, such as points of interest databases, outdoor advertising locations, and the like. An operator of the present invention may then contact establishments identified as landmark candidates, and may offer to sell them “advertising” to be displayed by the invention to users.

As a byproduct of use of the present invention, accurate metrics for route generation and advertising may be calculated, and may be used as a selling, pricing or billing mechanism.

### DETAILED DESCRIPTION OF THE DRAWINGS

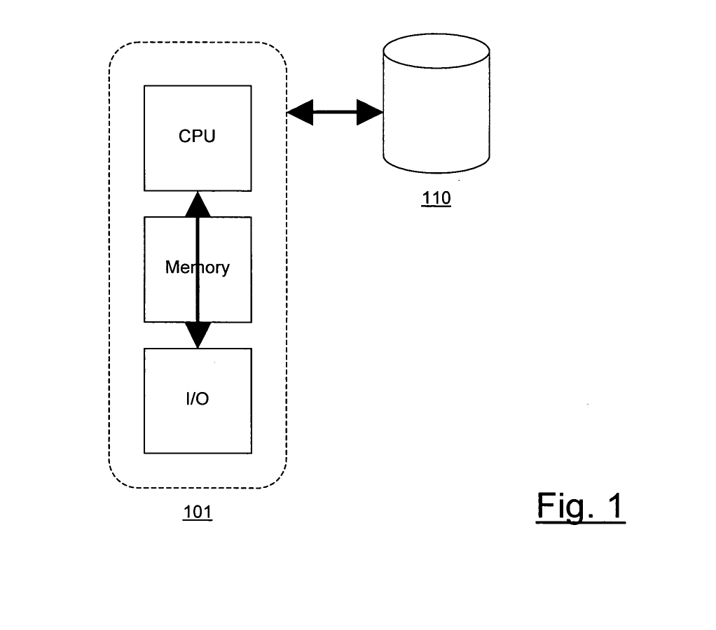

FIG. 1 is a block diagram of the system of the present invention.

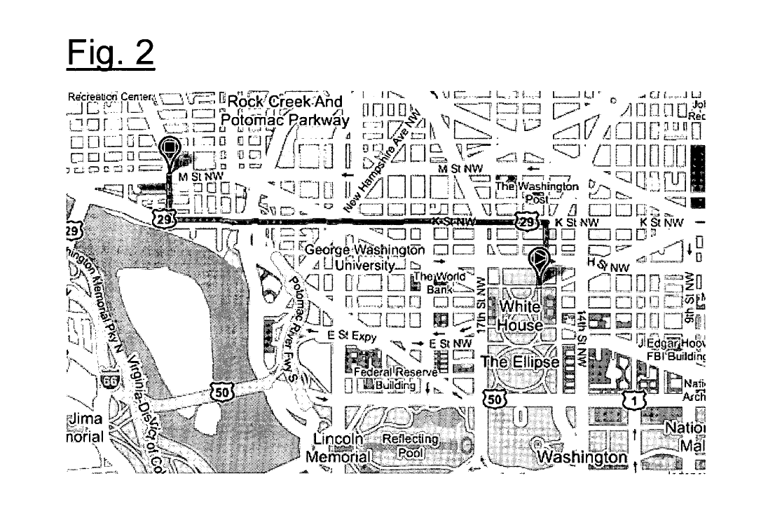

FIG. 2 is a map direction display of the prior art.

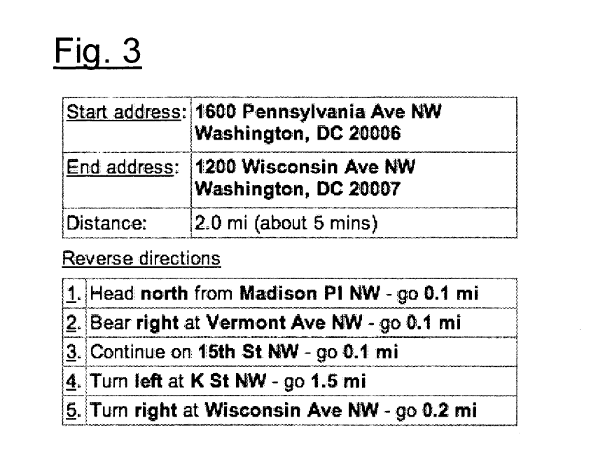

FIG. 3 is a textual direction display of the prior art.

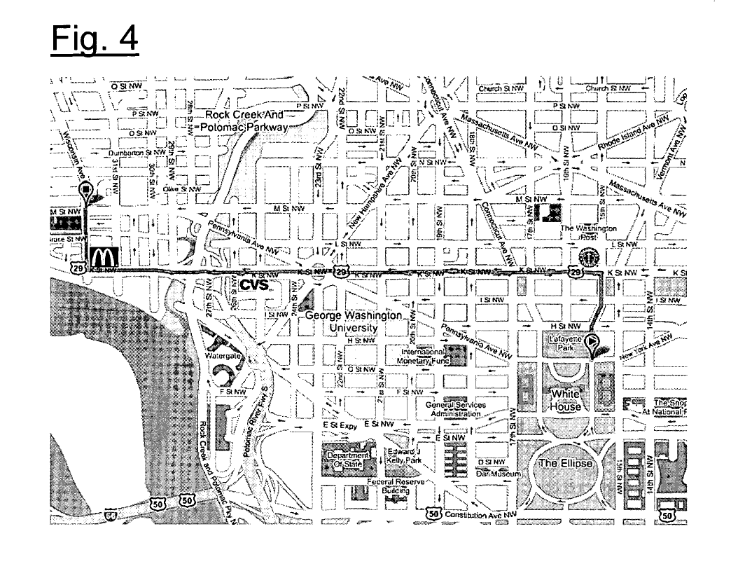

FIG. 4 is a map direction display according to the present invention.

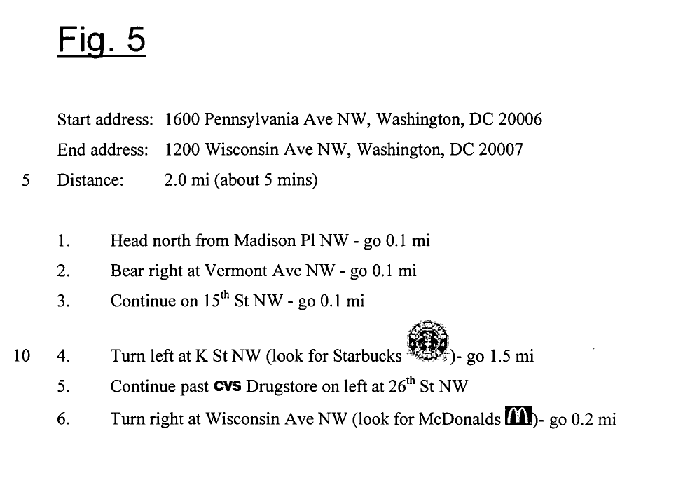

FIG. 5 is a textual direction display according to the present invention.

### DETAILED DESCRIPTION OF THE PREFERRED EMBODIMENT OF THE INVENTION

Referring now to FIG. 1, there is shown a block diagram of the system of the present invention. A general-purpose computer system 101, having at least one central processing unit, memory (such as random access memory, flash memory, or the like) associated with and accessible to the central processing unit, and nonvolatile storage memory (such as magnetic disk, flash memory, or the like), and input output systems (for instance, keyswitches, touch sensitive screen, voice recognition, visual displays, printers, and/or audio output such as voice synthesis) is provided with access to a stored set of landmark data 1 10. Upon user indication of a departure point and a destination point, an algorithm for routing is performed to generate a set of directions for travel between the departure and destination points, comprising one or more “legs” (each leg being a single direction-giving statement for reaching a successive “waypoint”.)

For each waypoint, and for intermediate points in close proximity to the route of travel on each leg, the stored landmark data is searched to determine whether a landmark lies on or near a waypoint or an intermediate point. If a near landmark is located in the stored landmark data, then an indication of that landmark is communicated by the system to the user in appropriate proximity (in either distance or time) to the waypoint or intermediate point, so that the landmark may be used as a sensory reference during navigation.

Referring now to FIG. 2, there is shown a map direction display according to the prior art. As shown in the map captured from http://www.maps.google.com, a departure point (a symbol rendered in green on the screen, containing a right-facing triangle) and a destination point (rendered in red on the screen, containing a square) are connected by a suggested route of travel. In particular, the route of travel is seen to pass nearby to labeled locations including “The Washington Post” and “George Washington University” but there is no indication that either of these is visually distinctive, can be seen from the suggested route of travel, or is useful as a sensory reference during navigation of the route. In the event that either of these labeled locations desires to become an advertising landmark in the present invention, particular features would be incorporated that serve as sensory cues, such as, for example, “Clocktower at George Washington University”.

Referring now to FIG. 3, there is shown a set of travel directions corresponding to the route map of the prior art shown in FIG. 2. The directions for travel (also captured from http://www.maps.google.com) comprise a set of street names, distances, and directions (both cardinal, such as “travel North” and relative, such as “turn right”.) These prior art directions, while useful and accurate, are devoid of sensory reference points, such as may be found useful by those more inclined to navigate with reference to landmarks.

Referring now to FIG. 4, there is shown a map display according to the present invention. (The landmark information is hypothetical, and is not drawn from actual information about landmarks located along the route of travel, and is presented as an illustration only.) In addition to symbols indicative of the departure and destination points, other symbols have been displayed. In particular, a logo for Starbucks Coffee is displayed at the first indicated turn as being on the Northwest corner of the intersection; a CVS drugstore logo is displayed along the route; and a McDonalds restaurant logo is displayed at the Northeast comer of the next turn. (None of these trademark owners has given permission for use of their respective marks herein, and they are used only by example.)

Referring now to FIG. 5 there is shown textual directions for the route of travel depicted in FIG. 4. At each step where a landmark is found in the stored landmark data, a textual indication (in combination with a graphic symbol indicative of the landmark) is displayed. Alternatively, just the graphic “icon”, another symbol, or just the textual indication may be used.

According to the method of the present invention, a new form of “advertising inventory” is created. Items selected from inventory are specific to each individually requested route and may be personalized for the user making the request. Thus, there exist infinite combinations of “advertising” opportunities for incorporation into routing maps and instructions.

Advertising inventory is understood by those in the advertising field to comprise available “impressions” or places in media streams where an advertiser's message may be presented to a consumer. Conventionally, such inventory includes items such as magazine pages, television and radio advertising “spots” (units of time in the broadcast schedule for sale to advertisers) and billboard locations (such as outdoor billboards, the sides of buses, and the like. On the Internet, advertising inventory includes “banner” advertisements, interstitial advertising (inserted into content areas of web pages), “popup” advertisements (and their cousins, “popunder” advertisements) and subject-based advertising such as Google's AdSense system.

Although it has long been possible to geolocate a business, as is commonly done on classified advertising sites that offer to present a map showing the location of a particular business located by search, and to display businesses of a particular type on a map, the correlation of routes of travel to the use of business locations as landmarks has not been practiced. Thus, for any possible route of travel, there exist a large number of landmark locations that correspond to advertising and sponsorship interests.

For instance, for a given street intersection, there may be several business concerns located at the intersection, and visible from a given direction of approach. At a hypothetical four-way intersection, there may be an Exxon-Mobil gasoline station on the Northwest corner, a BP gasoline station on the Southeast corner, a Wawa convenience store on the Northeast corner and State University on the Southwest corner. Thus, these four establishments may wish to have their information displayed to users (in both graphic and textual displays) whose requested routes will carry them through the intersection. Similarly, on a road along a given route, an outdoor advertising company may have a billboard currently advertising a particular product, and may wish that this billboard serve as a landmark, thus displaying an advertising message to those traveling routes that pass by the billboard.

The landmarks employed need not be strictly visual. For example, a landmark may be communicated to the user instructing that she, “roll down the windows and smell the chocolate at the Hershey factory on Chocolate Avenue.”

It is envisioned that a particular location's advertising landmark may be selected or filtered according to a number of methods. For instance, an auction among advertisers may be used to select the one that will be incorporated into route information. Alternatively, or in combination with such an auction, selection criteria may also be applied. Criteria such as direction of approach may be used (e.g., preferring landmarks on the side of the road closest to the direction of travel.) User preferences may also be employed (e.g., do not show fast food restaurants) as well as inferred preferences (e.g., the user was referred to the mapping site by the Target.com site, so always show the location of Target stores.) Among the data that may be employed in the selection process is route information, Internet-based information (“cookies”, referrer site, history of sites visited, etc.), and both inferred and explicit personal profile information.

Enhancing the value of both the advertising inventory and the advertising itself, the method of the present invention provides for measurement of actual impressions delivered to anonymous as well as indentified (registered) users. Using mapping systems on the Internet, it is possible to log the number of routes generated that include travel past a specific location. At the option of the operator of the mapping system, advertisers may even be charged based on the actual delivery of impressions, i.e., inclusion of advertiser information in directions, maps, or both.

For system operators, selling advertising inventory may begin with a process that identifies available locations along routes, and correlates these with available information about potential advertisers, such as Yellow Pages databases and geolocation systems. Thus, for a given intersection, it may be possible to identify those business concerns located within a visible radius, their locations, and their contact information that may be used to sell them advertising through the mapping system. Similarly, other sources of information may be “mined” and other landmarks may be incorporated to increase the usefulness of the directions to both advertisers and end users. (For instance, a prominent non-advertiser landmark may be incorporated if it aids in navigation. Such non-advertiser landmarks may, nevertheless, be sponsored by advertisers, if desired—(Turn left at the blue water tower: sponsored by Dasani.)

As another method of acquiring advertising inventory, outdoor advertising companies may directly transmit sign locations and current contents to system operators for inclusion in directions, and system operators may transmit route generation statistics to outdoor advertising companies as a demonstration of the value of placing advertising along a given route.

Finally, all of the methods and systems of the present invention may be embodied in an in-vehicle or portable global positioning satellite (GPS) based navigation device, in which advertising inventory is used as a points-of-interest database loaded into the device. Thus, even spoken directions during routed trips may include such instructions as “In 400 feet, turn right at the McDonalds onto Main Street.”

While the invention has been described in its preferred embodiments, it is to be understood that the words which have been used are words of description rather than of limitation and that changes may be made within the purview of the appended claims without departing from the true scope and spirit of the invention in its broader aspects. Rather, various modifications may he made in the details within the scope and range of equivalents of the claims and without departing from the spirit of the invention. The inventor further requires that the scope accorded her claims be in accordance with the broadest possible construction available under the law as it exists on the date of filing hereof and that no narrowing of the scope of the appended claims be allowed due to subsequent changes in the law, as such a narrowing would constitute an ex post facto adjudication, and a taking without due process or just compensation.

I claim as my invention:

1. A method for advertising comprising the steps of:
a. determining a route of travel comprised of at least two waypoints, being at least a starting waypoint and an ending waypoint;
b. associating one or more advertisements with a landmark located in close proximity to at least one waypoint on the route;
c. selecting at least one advertisement from among the associated advertisements;
d. communicating the route of travel together with the selected advertisements;
wherein the advertisements serve as indicators of sensory landmarks to a user traversing the route of travel.

2. The method of claim 1 wherein the route is generated according to a routing algorithm.

3. The method of claim 1 wherein the landmark is a commercial building, public building, or plurality of buildings.

4. The method of claim 1 wherein the landmark is an outdoor sign.

5. The method of claim 1 wherein the method of selecting the advertisement comprises an auction among advertisers.

6. The method of claim 1 wherein the method of selecting the advertisement comprises preferring landmarks on the side of the route associated with the direction of travel.

7. The method of claim 1 where in the method of selecting the advertisement comprises filtering according to one or more criteria selected from the group of explicit personal preferences; inferred personal preferences; website referrer; stored cookies; web browser history file contents; and route-based information.

8. The method of claim 1 wherein the displayed route is presented in the form of a graphic map, and each selected advertisement is placed graphically at the appropriate location on the map.

9. The method of claim 8 wherein the advertisement is a graphic element representing the landmark.

10. The method of claim 1 wherein the displayed route is presented as a set of textual directions, and each selected advertisement is placed at the appropriate location within the sequence of directions.

11. The method of claim 10 wherein the advertisement is a graphic element representing the landmark.

12. The method of claim 1 wherein the communicating is through a web browser connected to the Internet.

13. The method of claim 1 wherein the communicating is through a printing device.

14. The method of claim 1 wherein the communicating is a device located in the passenger compartment of a vehicle.

15. The method of claim 1 wherein the communicating is through a hand-held GPS-enabled device.

16. The method of claim 1 wherein the communicating is a set of spoken directions, and each selected advertisement is spoken at an appropriate location within the sequence of spoken directions.

17. The method of claim 16 wherein each selected advertisement is a prerecorded commercial message.

18. A method of soliciting advertising to be displayed as landmarks in travel directions comprising:
a. identifying, for a geographic area, each potential waypoint that may be included in a set of travel directions;
b. for each identified waypoint, determining the geographic locations of landmarks in close proximity to the waypoint;
c. communicating an offer to include the landmark in a set of landmarks from which to select when composing travel directions to an offeree;
d. if the communicated offer is accepted by the offeree, then including information about the landmark in the set of landmarks.

19. A method of soliciting advertising to be displayed as landmarks in travel directions wherein determining the geographic locations of landmarks in close proximity to the waypoint comprises searching one or more databases containing indications of the geographic locations of landmarks in close proximity to the waypoint.

20. A system for advertising comprising:
a. means for determining a route of travel comprised of at least two waypoints, being at least a starting waypoint and an ending waypoint;
b. means for associating one or more stored records representative of advertisements with a stored record representative of a landmark located in close proximity to at least one waypoint on the route;
c. means for selecting at least one advertisement record from among the associated advertisements;
d. means for communicating the route of travel together with the selected advertisements;
wherein the advertisements serve as indicators of sensory landmarks to a user traversing the route of travel.
